(19) United States
(12) Patent Application Publication
(10) Pub. No.: US 2021/0068233 A1
(43) Pub. Date: Mar. 4, 2021

(54) ILLUMINATION CONTROL DEVICE, ILLUMINATION CONTROL METHOD, ILLUMINATION DEVICE, AND ILLUMINATION SYSTEM

(71) Applicant: SONY CORPORATION, TOKYO (JP)

(72) Inventors: YUICHIRO TAKEUCHI, TOKYO (JP); KUNIHIKO NAGAMINE, KANAGAWA (JP)

(21) Appl. No.: 16/960,219

(22) PCT Filed: Nov. 7, 2018
(86) PCT No.: PCT/JP2018/041293

§ 371 Date: Jul. 6, 2020

(30) Foreign Application Priority Data
Jan. 16, 2018 (JP) 2018-005133

(51) Int. Cl. H05B 47/105; F21V 5/00; H04N 9/31

(52) U.S. Cl. CPC H05B 47/105; H04N 9/3158; H04N 9/3155; F21V 5/007

(57) ABSTRACT

An illumination control device and an illumination control method for controlling an illumination device that is able to reproduce a light beam, an illumination device, and an illumination system are provided. An illumination control device, which controls an illumination device including a spatial light modulator and a lenticular sheet, includes a determination unit that determines information regarding a position and a type of a light source, a light beam calculation unit that calculates a light beam to be emitted from each point on a surface of the illumination device in order to reproduce the determined light source, a pixel value determination unit that determines a pixel value of each pixel of the spatial light modulator to realize the calculated light beam, and a control unit that controls the spatial light modulator on the basis of the determined pixel value.

### TECHNICAL FIELD

The technology disclosed herein relates to an illumination control device and an illumination control method for controlling an illumination device that can reproduce a light beam, an illumination device, and an illumination system.

### BACKGROUND ART

In the field of vision engineering or the like, a light beam reproduction technology, called “Integral Imaging”, for controlling a direction of a light beam output from a display by a lenticular sheet has been known. According to Integral Imaging, an image that looks different depending on a viewpoint can be generated. Integral Imaging is applied to, for example, a naked-eye 3D display and the like.

In more recent years, “Integral Illumination” has been proposed that applies the light beam reproduction technology using a lenticular sheet to an indoor illumination device and dynamically controls an indoor illumination (for example, refer to Patent Document 1).

### CITATION LIST

### Patent Document

Patent Document 1: WO 2017/033553 A

### SUMMARY OF THE INVENTION

### Problems to be Solved by the Invention

An object of the technology disclosed herein is to provide an illumination control device and an illumination control method for controlling an illumination device that can reproduce a light beam, an illumination device, and an illumination system.

### Solutions to Problems

A first aspect of the technology disclosed herein is an illumination control device that controls an illumination device including a spatial light modulator and a lenticular sheet, the device including:

a determination unit that determines information regarding a position and a type of a light source;

a light beam calculation unit that calculates a light beam to be emitted from each point on a surface of the illumination device in order to reproduce the determined light source;

a pixel value determination unit that determines a pixel value of each pixel of the spatial light modulator to realize the calculated light beam; and

a control unit that controls the spatial light modulator on the basis of the determined pixel value.

The determination unit determines the information regarding the position and the type of the light source on the basis of an input to a user interface. The user interface presents a selectable light source preset on a GUI screen or the like. Furthermore, the user interface receives an input of a parameter including at least one of brightness of a light source, a color of light, a change with time, and installation of a mask that shields a part of light emitted from the light source. Furthermore, the user interface receives a drag operation performed to instruct a position or a direction of a light source.

The light beam calculation unit calculates a predetermined number of light beams emitted from the light source on the basis of the Monte Carlo method, selects a lenslet that emits the light beam on the basis of an intersection of each light beam with a surface of the illumination device, and defines a light beam group to be emitted by each lenslet. Then, the pixel value determination unit selects a direction closest to each light beam in the group from among a finite number of directions in which the lenslet can emit light beams and determines a pixel value of a pixel that emits the light beam on the basis of the parameter allocated to the light beam.

Furthermore, a second aspect of the technology disclosed herein is an illumination control method for controlling an illumination device including a spatial light modulator and a lenticular sheet, the method including:

determining information regarding a position and a type of a light source;

performing light beam calculation for calculating a light beam to be emitted from each point on a surface of the illumination device in order to reproduce the determined light source; and

performing pixel value determination for determining a pixel value of each pixel of the spatial light modulator to realize the calculated light beam.

Furthermore, a third aspect of the technology disclosed herein is an illumination device including:

a spatial light modulator;

a backlight; and

a lenticular sheet that controls a direction of light emitted from each pixel of the spatial light modulator, in which

the lenticular sheet includes a plurality of lenslets and a frame that supports the plurality of lenslets on a two-dimensional plane.

Furthermore, a fourth aspect of the technology disclosed herein is an illumination system including:

an illumination device including a spatial light modulator and a lenticular sheet;

a user interface that inputs information regarding a position and a type of a light source; and

an illumination control unit that calculates a light beam to be emitted from each point on a surface of the illumination device in order to reproduce the light source determined on the basis of the input, determines a pixel value of each pixel of the spatial light modulator to realize the light beam, and controls the spatial light modulator.

However, “system” here indicates a plurality of devices (or functional module for realizing specific function) that is logically collected, and it does not matter whether or not the devices or functional modules are provided in a single housing.

### Effects of the Invention

According to the technology disclosed herein, an illumination control device and an illumination control method for controlling an illumination device to which Integral Illumination is applied, an illumination device, and an illumination system can be provided.

Note that the effects described herein are only exemplary, and the effect of the present invention is not limited to those. Furthermore, there is a case where the present invention has a further additional effect other than the effects described above.

Other purpose, characteristics, and advantages of the technology disclosed herein would be obvious by the detailed description based on the embodiment described later and the attached drawings.

### BRIEF DESCRIPTION OF DRAWINGS

FIG. 1 is a diagram illustrating an exemplary configuration of an illumination system 100.

FIG. 2 is a diagram illustrating an exemplary configuration of a GUI screen used to select a light source by a user.

FIG. 3 is a diagram schematically illustrating a light beam emitted from a POINT light source.

FIG. 4 is a diagram schematically illustrating a light beam emitted from a SPOT light source.

FIG. 5 is a diagram schematically illustrating a light beam emitted from a LINEAR light source.

FIG. 6 is a diagram illustrating a state where a position and a direction of a light source in a three-dimensional space are operated through a drag operation on the GUI screen.

FIG. 7 is a diagram illustrating a light beam that is emitted from a light source and is calculated by light beam calculation.

FIG. 8 is a diagram illustrating a state where a single light beam defined by the light beam calculation intersects with a surface of an illumination device 110.

FIG. 9 is a diagram illustrating a lenslet at a position closest to an intersection with a light beam.

FIG. 10 is a diagram illustrating a state where a single lenslet is arranged on a 32×32 pixel array.

FIG. 11 is a diagram illustrating a state where a plurality of light beams having different colors (and brightness) and directions is emitted from a top surface of a single lenslet.

FIG. 12 is a diagram illustrating a state where an emission direction from the top surface differs according to an entrance position of a light beam on a bottom surface of the lenslet.

FIG. 13 is a diagram illustrating a finite number of directions in which the lenslet can emit light beams.

FIG. 14 is a diagram illustrating a single light beam included in a light beam group defined for the lenslet.

FIG. 15 is a diagram illustrating a light beam that is finally selected.

FIG. 16 is a diagram illustrating the lenslet.

FIG. 17 is a diagram illustrating a frame into which the lenslet is fitted.

FIG. 18 is a diagram illustrating a state where the lenslet is fitted into the frame.

FIG. 19 is a diagram illustrating an enlarged lenslet fitted into the frame.

FIG. 20 is a diagram illustrating a bottom surface of the frame into which the lenslet has been fitted.

FIG. 21 is a diagram illustrating a state where the bottom surface of the frame is coated with strippable paint.

FIG. 22 is a diagram illustrating a state where a film is formed by coating a front side of the bottom surface of the frame with the strippable paint.

FIG. 23 is a diagram illustrating a state where a funnel-shaped tool is attached to a top surface of the frame after the film is formed on the bottom surface.

FIG. 24 is a diagram illustrating a state where a heat-resistant adhesive is poured by using the funnel-shaped tool.

FIG. 25 is a diagram illustrating a state where the heat-resistant adhesives are poured from the funnel-shaped tools installed at a plurality of locations on the top surface of the frame.

FIG. 26 is a diagram illustrating the top surface of the frame after pouring the heat-resistant adhesive.

FIG. 27 is a diagram illustrating a state where the film is removed from the bottom surface of the frame.

FIG. 28 is a diagram illustrating a completed lenticular sheet.

### MODE FOR CARRYING OUT THE INVENTION

Hereinafter, an embodiment of the technology disclosed herein will be described in detail with reference to the drawings.

In recent years, “Integral Illumination” has been proposed that applies the light beam reproduction technology using a lenticular sheet to an indoor illumination device and dynamically controls an indoor illumination (for example, refer to Patent Document 1). Such an illumination can realistically reproduce various light sources such as artificial light of various illumination tools such as spotlights and chandeliers, natural light such as sunlight shining through the leaves of trees, crepuscular rays, or the like in addition to a normal fluorescent light by a single device, and various applications are expected.

Integral Illumination is realized by changing RGB values or a luminance value of each pixel of a spatial light modulator by using an illumination device including, for example, a spatial light modulator (SLM) that modulates backlight and a lenticular sheet laminated on a surface of the spatial light modulator. However, how to derive a pattern of the RGB values or the luminance value of each pixel to obtain a desired light source or illumination effect has not been sufficiently discussed yet. A direct operation of a pixel value of each pixel by a user is not intuitive and not realistic.

Furthermore, the lenticular sheet used for light beam control in Integral Illumination is different from a lenticular sheet used for a naked-eye 3D display or the like and has a complicated structure in which a transparent part and an opaque part mixedly exist. Although such a lenticular sheet can be easily manufactured by using 3D printing or the like, it is difficult to secure heat resistance with which the lenticular sheet can withstand for use as an illumination tool.

Here, a method for controlling the illumination device to derive the pattern of the RGB values or the luminance value of each pixel in order to obtain the desired light source or illumination effect and realize Integral Illumination, including a user interface, will be described. Furthermore, here, a method for easily manufacturing a lenticular sheet having high heat resistance and high quality will be described.

A. System Configuration

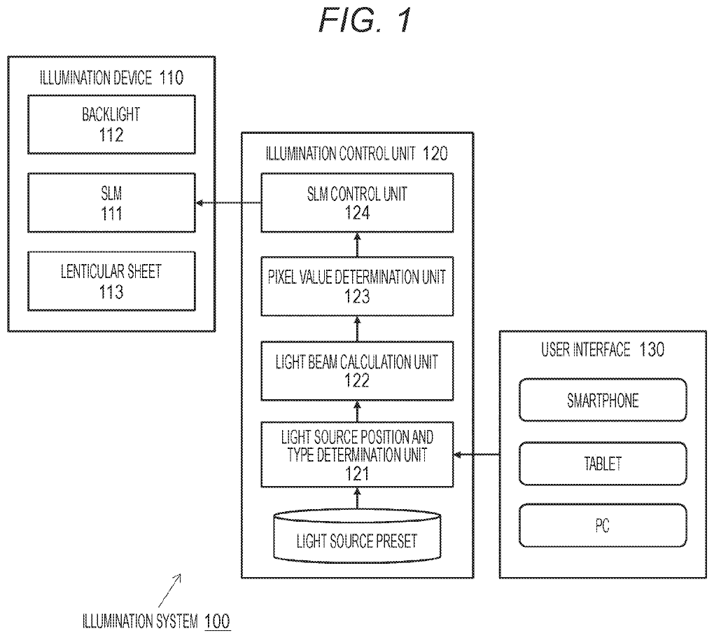

FIG. 1 schematically illustrates an exemplary configuration of an illumination system 100 to which the technology disclosed herein is applied. The illustrated illumination system 100 includes an illumination device 110, an illumination control unit 120, and a user interface 130. First, a function of each unit will be described.

The illumination device 110 is assumed to be a hardware device that can reproduce an arbitrary light source by applying the Integral Illumination technology. Specifically, the illumination device 110 includes an SLM 111, a backlight 112, and a lenticular sheet 113.

The SLM 111 is a flat panel on which a plurality of pixels is two-dimensionally arranged. The lenticular sheet 113 is laminated on a side of a display surface, and the backlight 112 is provided on the opposite side. Note that, a diffusion sheet may be laid between the backlight 112 and the SLM 111 in order to uniformly propagate irradiation light of the backlight 112 over the front surface of the SLM 111. However, illustration and detailed description are omitted here.

The SLM 111 is a device that electrically controls a spatial distribution (amplitude, phase, polarization, or the like) of light from a light source and changes (modulate) light and can include, for example, a liquid crystal panel.

The backlight 112 irradiates the SLM 111 from the back surface side and projects an image drawn on the SLM 111 on a front surface.

The lenticular sheet 113 is a transparent sheet configured by two-dimensionally arranging fine lenslets each having a convex top surface. After each pixel of the SLM 111 spatially modulates the irradiation light of the backlight 112, a light beam direction of the irradiation light is controlled by each lenslet of the lenticular sheet 113, and the irradiation light is emitted in various directions.

For example, the illumination device 110 according to the present embodiment can include the “light source unit”, the “lenticular lens”, and the “backlight” disclosed in WO 2017/033553 A (Patent Document 1).

The user interface 130 is a device that specifies information regarding a light source that a user desires to reproduce. For example, an existing information device such as a smartphone, a tablet, a personal computer (PC), or the like can be utilized as the user interface 130, and the user can specify the information regarding the light source (type of light source, position, direction, brightness, color, or the like of light source) through a Graphical User Interface (GUI) screen presented on the such an information device.

The illumination control unit 120 controls driving of the SLM 111 so as to reproduce a desired light source according to the information specified through the user interface 130. The illumination control unit 120 can be configured as a dedicated hardware device. However, the illumination control unit 120 can be implemented as software executed on the information device such as a PC. For example, the illumination control unit 120 may be the information device (smartphone, tablet, PC, or the like) included in the user interface 130 or software executed by a controller in the illumination device 110.

The illumination control unit 120 illustrated in FIG. 1 includes a light source position and type determination unit 121, a light beam calculation unit 122, a pixel value determination unit 123, and an SLM control unit 124.

Furthermore, in the present embodiment, the illumination control unit 120 prepares the information regarding the light source that can be specified by the user as a preset (light source preset). The user can select a desired light source preset via the GUI screen of the user interface 130 or the like and can further specify the position of the light source. Then, the light source position and type determination unit 121 determines a position and a type of a light source to be reproduced on the basis of operation content on the user interface 130.

In order to reproduce the light source specified via the user interface 130, the light beam calculation unit 122 calculates what kind of light beam is only required to be emitted from each point on the surface of the illumination device 110.

First, the light beam calculation unit 122 calculates a predetermined number of light beams emitted from the light source of which the type is determined by the light source position and type determination unit 121 from the determined position on the basis of a predetermined algorithm. Moreover, the light beam calculation unit 122 calculates an intersection of each light beam with the surface (irradiation surface) of the illumination device 110. Then, among the lenslets included in the lenticular sheet 113 on the side of the illumination device 110, a lenslet at a position closest to the calculated intersection is selected as a lenslet that emits the light beam. In this way, the light beam calculation unit 122 defines the light beam group to be emitted by each lenslet of the lenticular sheet 113. Each light beam has a direction expressed by a three-dimensional vector and a color and brightness (RGB values or luminance values (however, regarding luminance value, case where monochrome SLM is used is assumed)) as parameters.

A two-dimensional array of the pixels included in the SLM 111 is arranged below (bottom) each lenslet. Furthermore, in its design, the lenslet controls the color and the brightness (RGB value or luminance value) of each pixel positioned below the lenslet so that the direction of the light beam emitted from the convex top surface can be controlled. The pixel value determination unit 123 determines the position of the pixel used to control the light beam and the color and the brightness of the pixel (RGB value or luminance value) for each light beam in the light beam group to be emitted by the lenslet.

The SLM control unit 124 controls the driving of the SLM 111 on the side of the illumination device 110 on the basis of the color and the brightness (RGB value or luminance value) of each pixel determined by the pixel value determination unit 123. In this way, the illumination control unit 120 can reproduce the light source, in the illumination device 110, specified by the user via the user interface 130.

The illumination device 110 can not only simply change the color of the illumination light but also can reproduce light of spotlight, light of a decorative illumination tool such as chandeliers, and natural light such as sunlight shining through the leaves of trees, crepuscular rays shining between clouds, or the like.

B. Specific Control Method of Integral Illumination

Subsequently, a control method for realizing Integral Illumination by using the illumination system 100 described above including a user interface will be described in detail.

B-1. Light Source Specification via User Interface

In order to reproduce a desired light source, it is necessary to specify the color and the brightness (RGB value or luminance value) of each pixel of the SLM 111. However, it is not intuitive and difficult for the user to directly operate the pixel value of each pixel. Therefore, in the present embodiment, the user is made to be able to select a light source to be reproduced on the GUI screen of the user interface 130 including a smartphone, a tablet, a PC, or the like, and conversion into a pixel pattern to reproduce the selected light source is automatically performed by the illumination control unit 120.

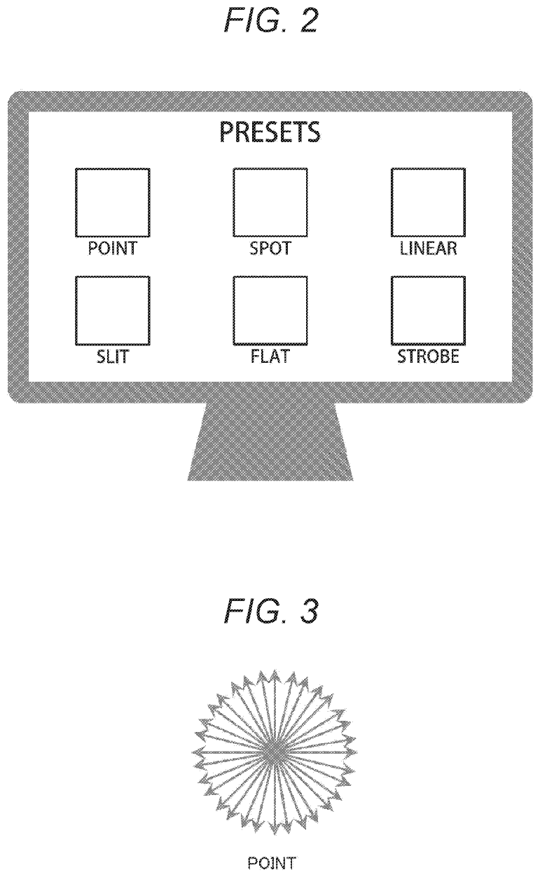

FIG. 2 illustrates an exemplary configuration of the GUI screen that is used to select the light source by the user and is presented by the user interface 130. The illustrated GUI screen includes a menu button used to select a plurality of light sources (POINT, SPOT, LINEAR, SLIT, FLAT, STROBE, . . . ) prepared as a light source preset.

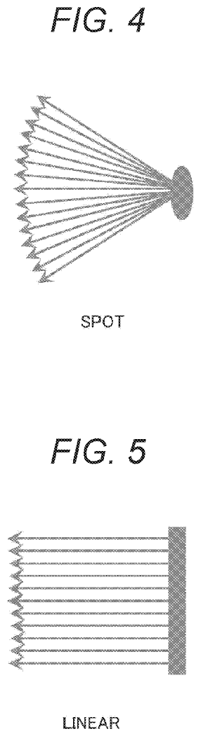

All the light sources can be defined by a combination of three types of light sources, that is, any one or two or more of POINT, SPOT, and LINEAR. POINT is a point light source that equally emits light in all directions. Furthermore, SPOT is a light source on a spotlight. Furthermore, LINEAR is a light source that emits parallel light. FIGS. 3 to 5 schematically illustrate light beams emitted from the respective light sources POINT, SPOT, and LINEAR.

The classification of the light sources such as POINT, SPOT, and LINEAR is used in the computer graphics (CG) field in general. Furthermore, by combining the three types of basic light sources POINT, SPOT, and LINEAR, it is possible to create a considerably complicated light source. On the GUI screen illustrated in FIG. 2, a menu button is prepared that is used to select SLIT (slit light source), FLAT (flat panel light source), and STROBE (light source that changes with times such as strobe) in addition to these basic light sources. Therefore, the user can specify the desired light source by combining the plurality of preset light sources through the GUI screen as illustrated in FIG. 2.

Furthermore, the user can adjust a parameter of each of the selected light sources. In other words, the user interface 130 receives an instruction input regarding the parameter of each of the selected light sources from the user. The parameter here includes, for example, brightness of a light source, a color of light, a change with time, installation of a mask that shields a part of the light emitted by the light source, or the like.

Moreover, the user can finely operate the position and the direction of each of the selected light sources in the three-dimensional space. In other words, the user interface 130 also receives an instruction input regarding the position and the direction of each of the selected light sources from the user. For example, the user can finely operate the position and the direction of the light source in the three-dimensional space through a drag operation on the GUI screen.

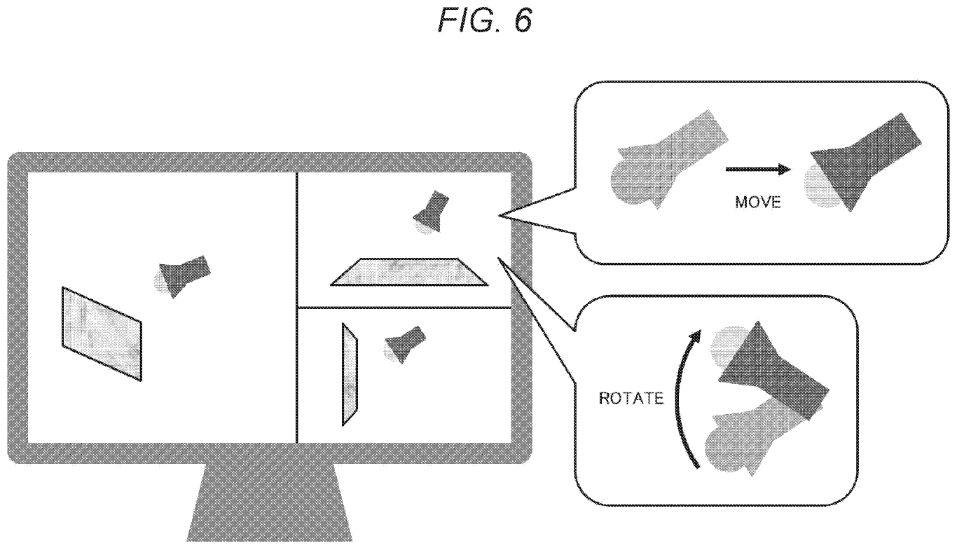

FIG. 6 illustrates a state where the position and the direction of the light source in the three-dimensional space are operated through the drag operation on the GUI screen. The user drags an icon indicating the light source on a back surface side of an installation position of the illumination device 110 such as a wall or a ceiling to instruct the position and the direction of the light source in the three-dimensional space. Specifically, the user can change the position of the light source by applying a moving drag operation (MOVE) to the icon, which has been already selected and indicates the light source, via, for example, the GUI screen illustrated in FIG. 2. Furthermore, the user can change the direction of the light source at the position (that is, direction of light beam to be emitted) through a drag operation (ROTATE) for rotating the icon which has been already selected and indicates the light source.

Then, the light source position and type determination unit 121 determines the position and the type of the light source to be reproduced and various other parameters (brightness of light source, color of light, change with time, installation of mask that shields a part of light emitted by light source, or the like) on the basis of content of an operation on the user interface 130.

B-2. Light Beam Calculation

In order to reproduce the light source specified via the user interface 130, the light beam calculation unit 122 calculates what kind of light beam is only required to be emitted from each point on the surface of the illumination device 110.

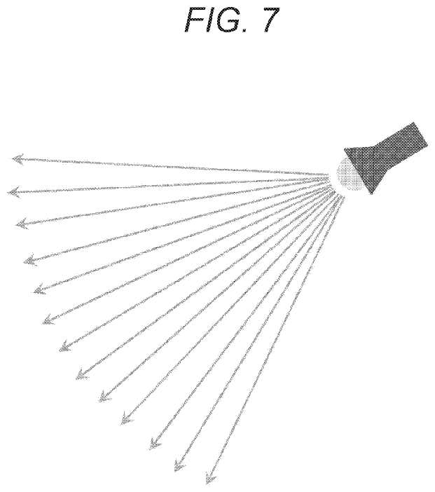

First, the light beam calculation unit 122 calculates a predetermined number of light beams emitted by the determined type of light source from the determined position by using a predetermined algorithm. Here, although the number of light beams to be calculated is, for example, 10000, the number may be increased or decreased according to the brightness of the light source specified by the user (increase the number if light source is bright and decrease the number if light source is dim). Furthermore, the light beam to be emitted from the light source may be calculated on the basis of an algorithm using a random number such as the Monte Carlo method. FIG. 7 illustrates a light beam that is emitted from the light source of which the position and the direction are determined and is calculated by the light beam calculation.

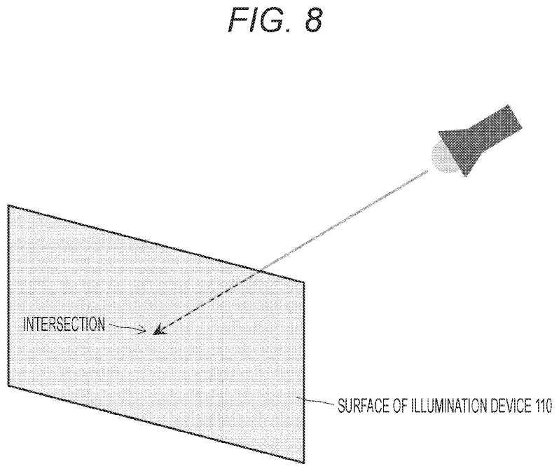

When the predetermined number of light beams emitted from the specified light source are defined by the light beam calculation, subsequently, an intersection of each light beam with the surface (irradiation surface) of the illumination device 110 is calculated. FIG. 8 illustrates a state where a single light beam defined by the light beam calculation intersects with the surface of the illumination device 110.

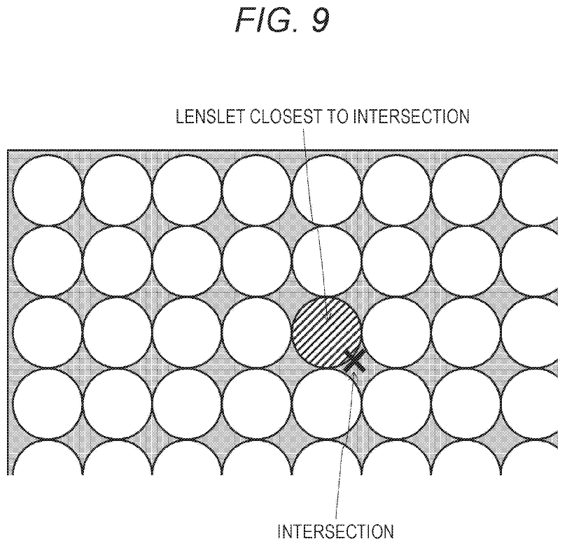

Furthermore, on the surface of the illumination device 110, the lenticular sheet 113 configured by two-dimensionally arranging fine lenslets each having a convex top surface is laid. The light beam calculation unit 122 selects the lenslet at the position closest to the intersection, which has been calculated above, between the light beam and the surface of the illumination device 1110 and sets the selected lenslet as a lenslet that emits the light beam. In FIG. 9, a lenslet at the position closest to the intersection with the light beam is shaded.

The light beam calculation unit 122 calculates the intersection between the light beam and the surface of the illumination device 1110 described above and selects the lenslet closest to the intersection for all the light beams on which the light beam calculation has been performed. In this way, the light beam group to be emitted by each lenslet of the lenticular sheet 113 can be defined. Each light beam has a direction expressed by a three-dimensional vector and a color and brightness (RGB values or luminance values (however, regarding luminance value, case where monochrome SLM is used is assumed)) as parameters.

B-3. Determination of Color and Brightness of Pixel under Each Lenslet

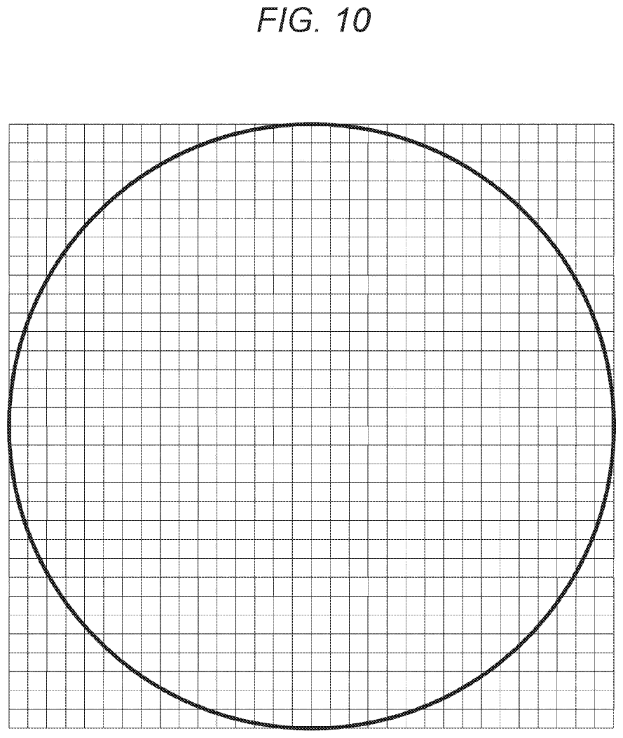

The lenslet included in the lenticular sheet 113 is a transparent cylindrical object having a diameter of about five mm to about 10 mm (for example, eight millimeter), and a convex lens is formed on the top surface of the lenslet. Furthermore, the two-dimensional array of the pixels included in the SLM 111 is provided below the lenslet. For example, as illustrated in FIG. 10, a single lenslet is arranged on a 32×32 pixel array. However, each single pixel includes one or more sub pixels of three primary colors RGB, and various colors can be displayed by specifying a value (gradation) of each color of RGB for each pixel.

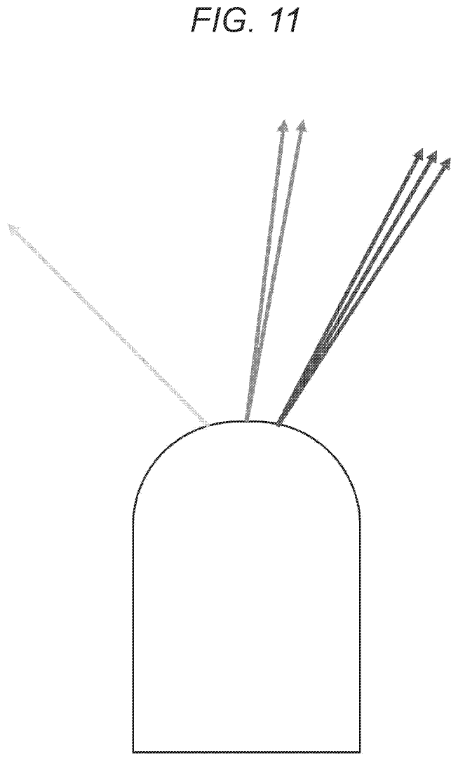

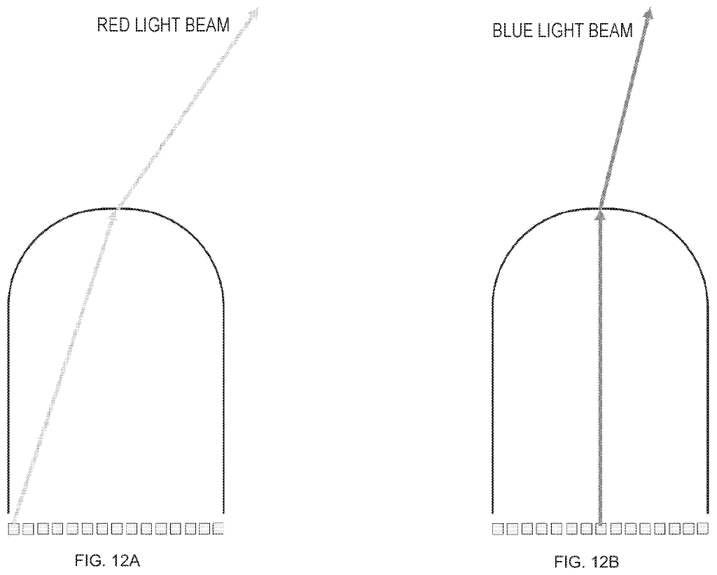

In the design, the lenslet controls the color and the brightness (RGB value or luminance value) of each pixel positioned below the lenslet so that the lenslet can emit the light beams in various directions by using the convex top surface. FIG. 11 illustrates a state where a plurality of light beams having different colors (and brightness) and directions is emitted from a top surface of a single lenslet.

The lenslet is designed so that an emission direction of the light beam from the convex top surface differs according to the entrance position of the light beam on the bottom surface. FIG. 12(A) illustrates a state where a red light beam entering from a pixel near a peripheral edge of the bottom surface of the lenslet is emitted in a direction corresponding to the position of the pixel from the top surface of the lenslet. Furthermore, FIG. 12(B) illustrates a state where a blue light beam entering from a pixel near the center of the bottom surface of the lenslet is emitted in a direction corresponding to the position of the pixel from the top surface of the lenslet. If FIGS. 12(A) and 12(B) are compared, it can be understood that the direction of the light beam emitted from the lenslet differs according to the position of the pixel.

However, even though the light beams can be emitted in various directions, in actual, it is necessary to determine the color and the brightness of the pixel as paying attention to that the lenslet can emit the light beams only in the finite number of directions.

Furthermore, a relationship between the brightness of the pixel and the brightness of the light emitted from the lenslet is not constant, and it is necessary to determine the color and the brightness of the pixel as paying attention to a point that the relationship differs according to the position of the pixel. This is because there is a case where all the light beams entering from the bottom surface of the lenslet are reflected by the top surface of the lenslet, a case where a part of the light beams are absorbed by a wall of the side surface of the lenslet, and a case where a part of the pixels are positioned outside the bottom surface of the lenslet, for example. Even in a case where the RGB values of the pixel are set to be maximum (255, 255, 255), it is necessary to determine the color and the brightness of the pixel as paying attention to a point that a luminance of light to be emitted differs (or attenuate light in lenslet) according to an entrance angle to the lenslet (position of pixel on bottom surface of lenslet).

The relationship between the brightness of the pixel and the brightness of the light emitted from the lenslet can be calculated on the basis of design of the lenslet, information regarding an SLM orientation distribution, and the like.

According to the process of the light beam calculation described above, the light beam group to be emitted from each lenslet has been already defined. Regarding each light beam in the group, the pixel value determination unit 123 selects a direction of a light beam closest to the light beam calculated by the light beam calculation unit 122 from among the finite number of directions in which the lenslet can emit the light beams.

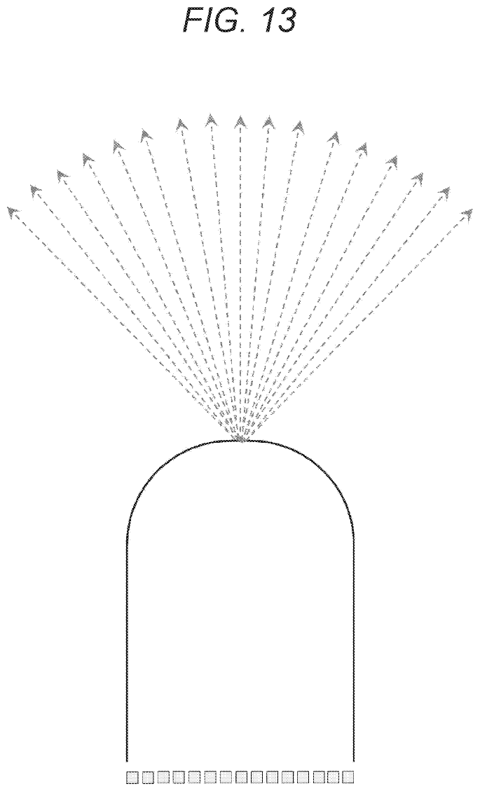

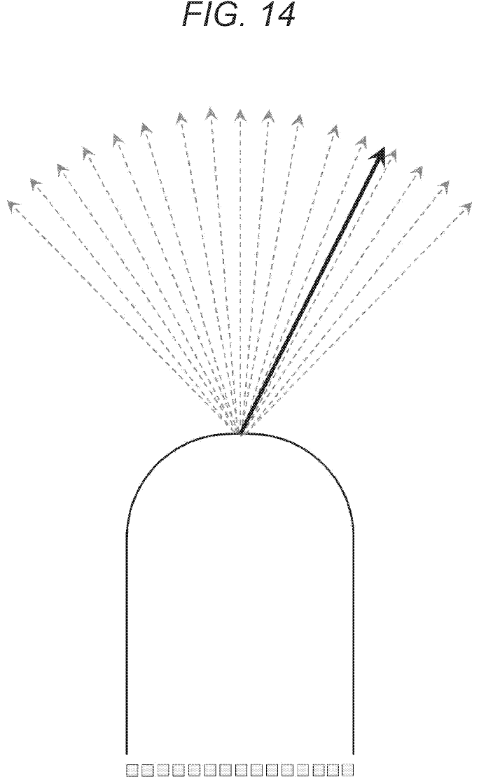

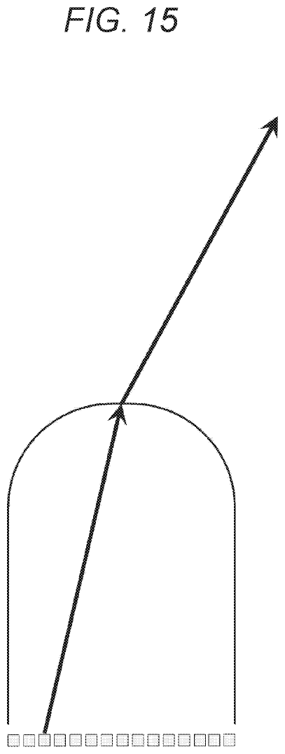

FIG. 13 illustrates the finite number of directions, in which the lenslet can emit the light beams, by dotted lines. Furthermore, in FIG. 14, a single light beam included in the light beam group defined for the lenslet is superimposed on the directions of the finite number of light beams that can be emitted (dotted line) and indicated by a solid line. The pixel value determination unit 123 selects a direction closest to the desired light beam from among the finite number of directions in which the lenslet can emit the light beam. The lenslet is designed so that an emission direction of the light beam from the top surface differs according to the entrance position of the light beam on the bottom surface (as described above). Therefore, the pixel value determination unit 123 can specify a pixel that emits the selected light beam as illustrated in FIG. 15, and it is only required for the pixel value determination unit 123 to control the color and the brightness (RGB value or luminance value) of the pixel.

In the process of the light beam calculation described above, the color and the brightness of the light beam are allocated as the parameters. The pixel value determination unit 123 calculates an actual pixel value on the basis of such information regarding the parameters. However, as described above, the relationship between the brightness of the pixel and the brightness of the light emitted from the lenslet is not constant, and it is necessary to determine the color and the brightness of the pixel as paying attention to a point that the relationship differs according to the position of the pixel.

The pixel value determination unit 123 executes processing for selecting the light beam as described above and determining the color and the brightness of the pixel for all the light beams so as to determine the RGB values or the luminance value of each pixel below the lenslet. Furthermore, by executing the similar processing on all the lenslets included in the lenticular sheet 113, it is possible to determine the RGB values or the luminance value of each pixel of the entire illumination device 110 (or entire SLM 111).

In this way, the illumination control unit 120 can convert information regarding the light source that is intuitively created by the user on the GUI screen into information regarding RGB values or a luminance value of each pixel used to reproduce the light source.

The SLM control unit 124 controls the driving of each pixel of the SLM 111 on the side of the illumination device 110 on the basis of the color and the brightness (RGB value or luminance value) of each pixel determined by the pixel value determination unit 123. With this operation, the illumination device 110 can reproduce the light source specified by the user via the user interface 130.

C. Method for Manufacturing Lenticular Sheet

The lenticular sheet is an integral component for Integrated Imaging and Integral Illumination, that is, the light beam reproduction technology.

The lenticular sheet used for Integral Illumination according to the present embodiment is different from a lenticular sheet used for a naked-eye 3D display or the like and has a complicated configuration in which a transparent part and an opaque part mixedly exist. A method for easily manufacturing such a lenticular sheet includes 3D printing. However, it is difficult to secure heat resistance with which the lenticular sheet can withstand for use as an illumination tool.

Therefore, here, a method will be described for easily manufacturing a lenticular sheet with high heat resistance and high quality by assembling individually-manufactured components without collectively creating a lenticular sheet as in the 3D printing.

C-1. Manufacturing Lenslet

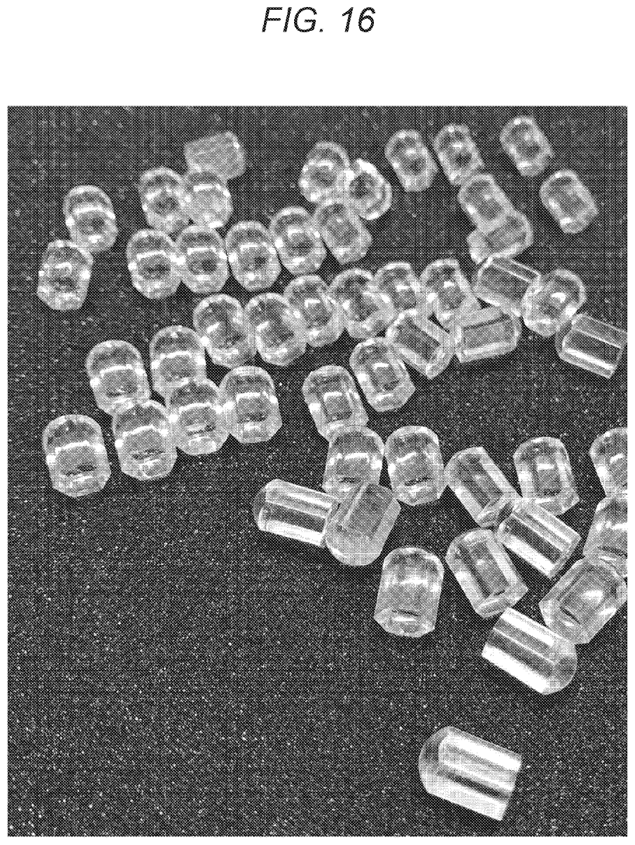

First, each lenslet is manufactured by using a material having high heat resistance such as polycarbonate. For example, a large number of lenslets having the same shape can be manufactured by using a molding technology such as injection molding. FIG. 16 illustrates a manufactured lenslet.

C-2. Manufacturing Frame

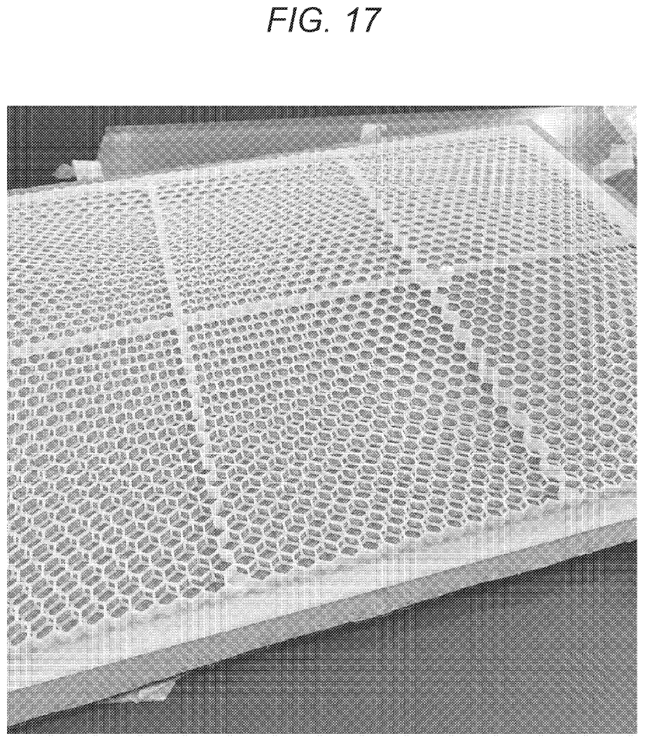

Subsequently, an opaque frame (frame) into which a lenslet is fitted is similarly manufactured by using a material having high heat resistance. FIG. 17 illustrates an exemplary configuration of the frame. The illustrated frame has a large number of sockets into which the respective lenslets are inserted and which are used to arrange the plurality of lenslets in a two-dimensional array. Although the frame illustrated in FIG. 17 has a complicated shape, the frame can be manufactured, for example, by using the 3D printing.

C-3. Fitting of lenslet

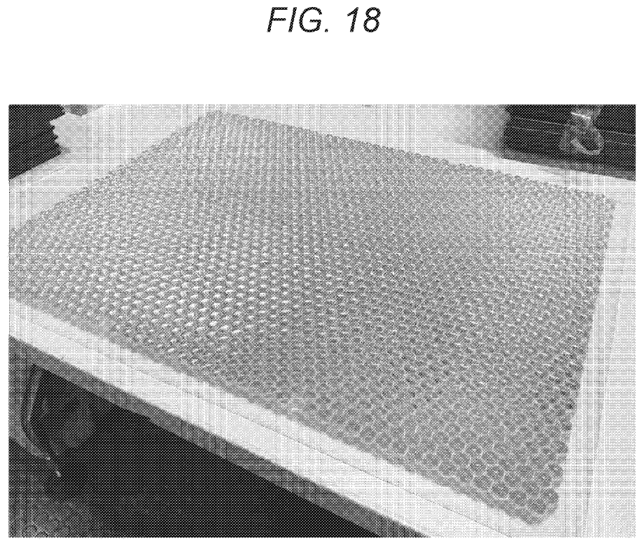

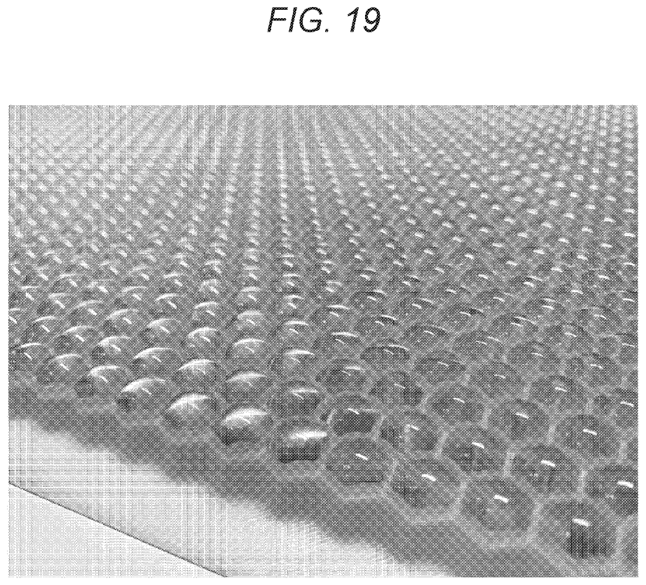

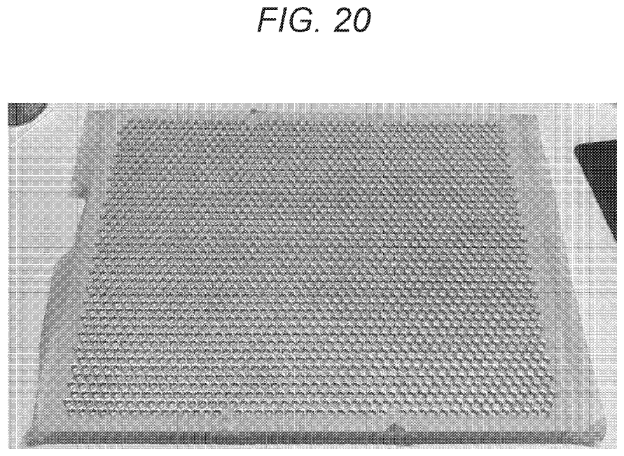

Subsequently, the lenslet is fitted into each slot of the frame. FIG. 18 illustrates a state where the lenslet is fitted into the frame. Furthermore, FIG. 19 illustrates an enlarged lenslet fitted into the frame. An operation for fitting each lens slot into the frame may be manually performed or automated by using an industrial robot or the like.

C-4. Protection of Bottom Surface

As described later, before a heat-resistant adhesive is poured into a gap between the lenslet and the frame, a film to prevent leakage of the adhesive from the bottom surface is formed. For example, the film is formed by coating the bottom surface of the frame into which the lenslet has been fitted with a temporary protection paint such as strippable paint.

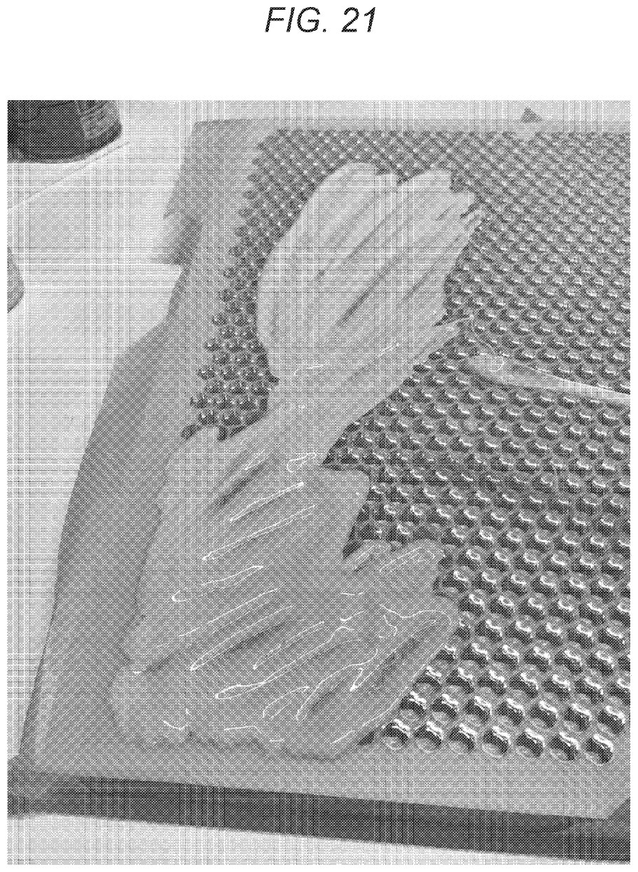

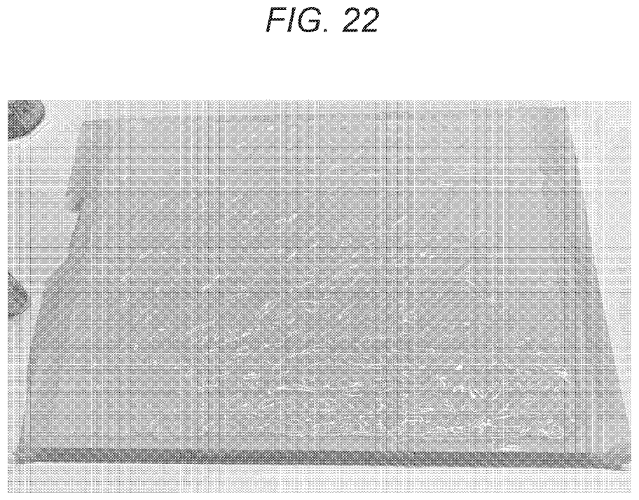

FIG. 20 illustrates the bottom surface of the frame into which the lenslet has been fitted. Furthermore, FIG. 21 illustrates a state where the bottom surface of the frame is coated with the strippable paint. Furthermore, FIG. 22 illustrates a state where the film is formed by coating a front side of the bottom surface of the frame with the strippable paint.

C-5. Pouring Heat-Resistant Adhesive

As described above, after the film is formed on the bottom surface of the frame into which the lenslet is fitted and is protected, the heat-resistant adhesive is poured from the side of the top surface of the frame into the gap between the lenslet and the frame. In this process, a dispenser or the like may be used, or a funnel-shaped tool may be used.

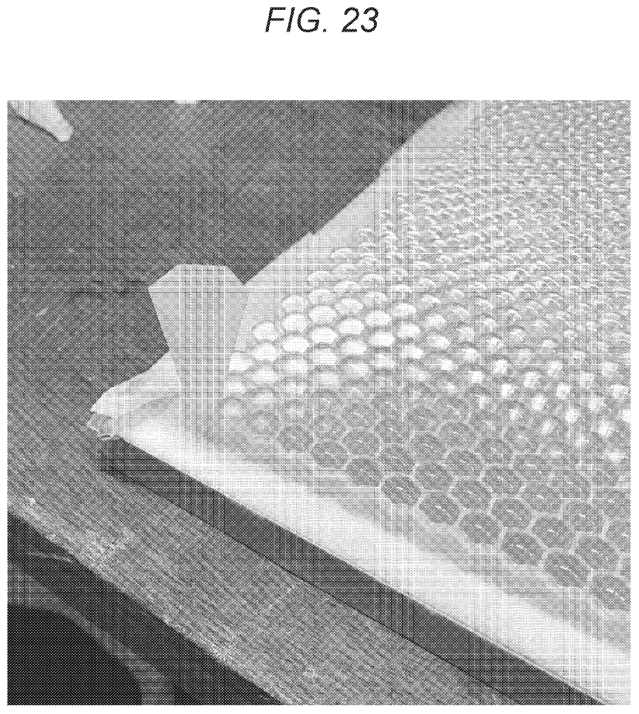

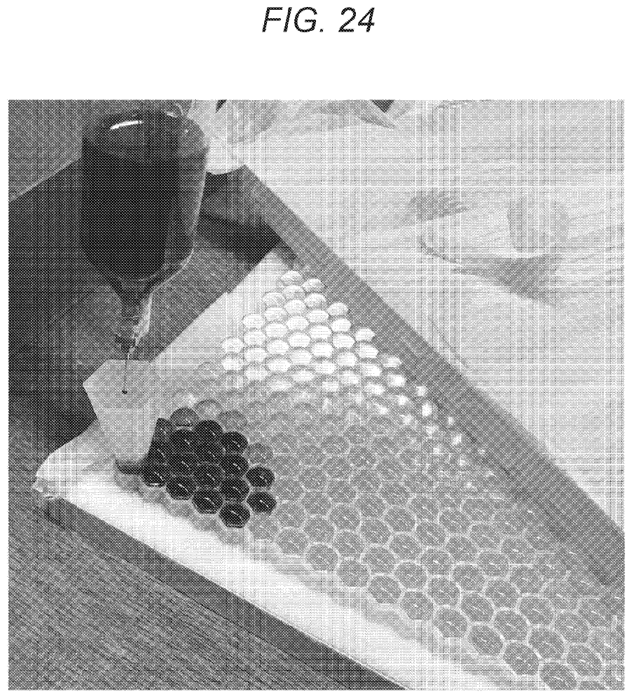

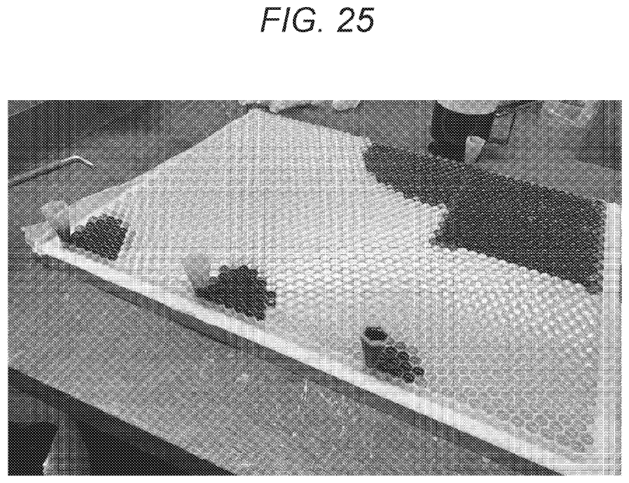

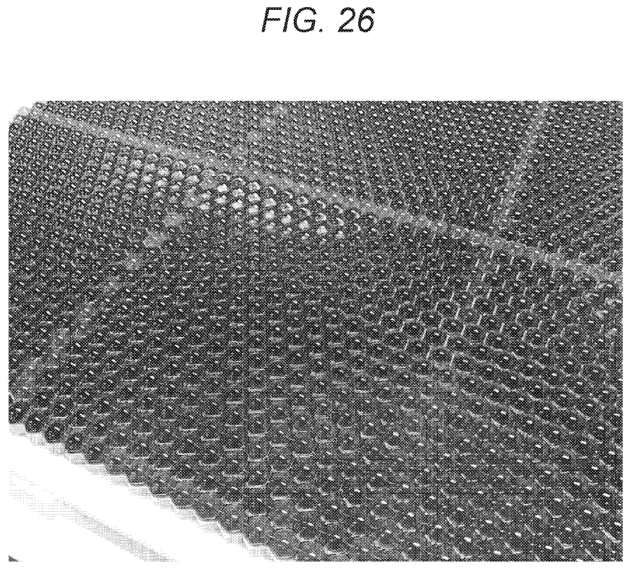

FIG. 23 illustrates a state where the funnel-shaped tool is attached to the top surface of the frame after the film is formed on the bottom surface. Furthermore, FIG. 24 illustrates a state where the heat-resistant adhesive is poured by using the funnel-shaped tool. Furthermore, FIG. 25 illustrates a state where the heat-resistant adhesive is poured from each of the funnel-shaped tools installed at a plurality of locations on the top surface of the frame. Furthermore, FIG. 26 illustrates a state of the top surface of the frame into which the heat-resistant adhesive has been poured.

C-6. Drying and Post-Processing

After the heat-resistant adhesive has been poured, drying processing is executed to cure the heat-resistant adhesive. Then, when the heat-resistant adhesive is cured, the film on the bottom surface is removed.

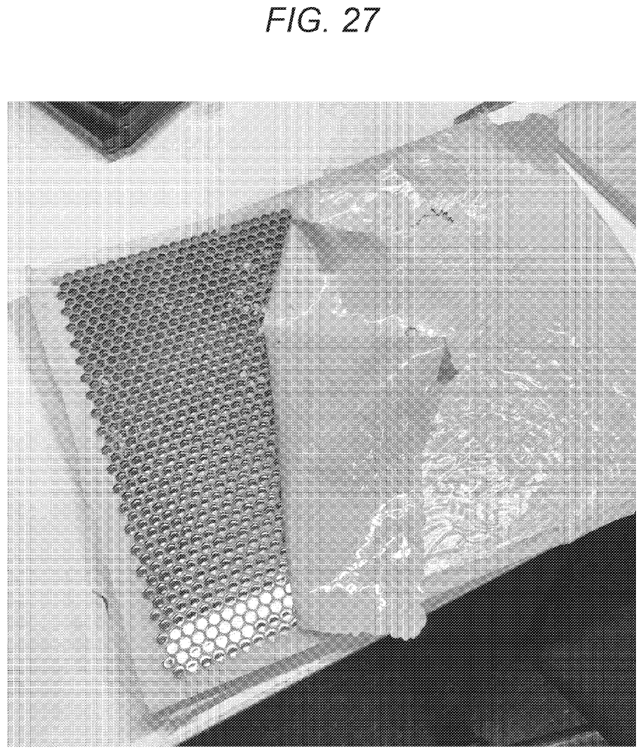

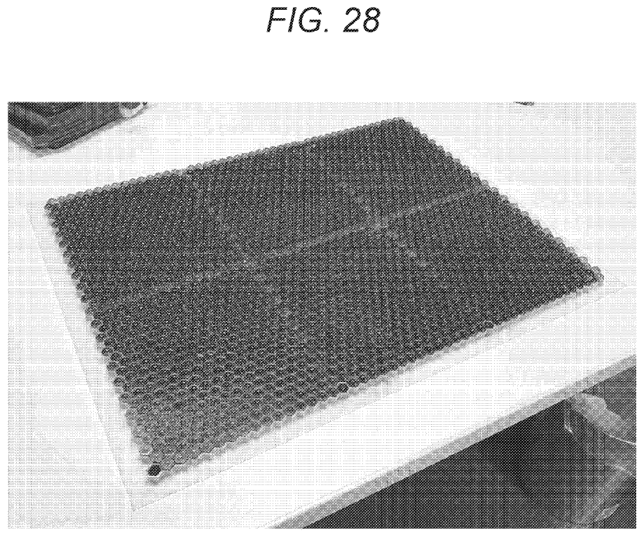

FIG. 27 illustrates a state where the film is removed from the bottom surface of the frame. Furthermore, FIG. 28 illustrates a completed lenticular sheet.

### INDUSTRIAL APPLICABILITY

The technology disclosed herein has been described above in detail with reference to the specific embodiment. However, it is obvious that those skilled in the art can amend and substitute the embodiment without departing from the scope of the technology disclosed herein.

The illumination device to which the technology disclosed herein is applied can be used as being installed, for example, on a ceiling, a wall, a floor, or the like of a room. The illumination device to which the technology disclosed herein is applied can simply adjust the color and the intensity and can also control the light beams. Furthermore, the illumination device can realistically reproduce various light sources such as artificial light of the illumination tool such as spotlights and chandeliers, natural light such as sunlight shining through the leaves of trees or crepuscular rays, or the like.

In a word, the technology disclosed herein has been described as an example, and the described matter in the present specification should not be restrictively interpreted. Claims should be considered in order to determine the scope of the technology disclosed herein.

Note that the technology disclosed herein can have the following configuration.

(1) An illumination control device that controls an illumination device including a spatial light modulator and a lenticular sheet, the illumination control device including:

a determination unit configured to determine information regarding a position and a type of a light source;

a light beam calculation unit configured to calculate a light beam to be emitted from each point on a surface of the illumination device in order to reproduce the determined light source;

a pixel value determination unit configured to determine a pixel value of each pixel of the spatial light modulator to realize the calculated light beam; and

a control unit configured to control the spatial light modulator on the basis of the determined pixel value.

(2) The illumination control device according to (1), in which

the determination unit determines the information regarding the position and the type of the light source on the basis of an input to a user interface.

(3) The illumination control device according to (2), further including:

the user interface.

(4) The illumination control device according to (2) or (3), in which

the user interface presents a selectable light source preset.

(5) The illumination control device according to any one of (2) to (4), in which

the user interface receives an input of a parameter including at least one of brightness of a light source, a color of light, a change with time, and installation of a mask that shields a part of light emitted from the light source.

(6) The illumination control device according to any one of (2) to (5), in which

the user interface receives a drag operation performed to instruct a position or a direction of a light source.

(7) The illumination control device according to any one of (1) to (6), in which

the light beam calculation unit calculates a predetermined number of light beams emitted from the light source on the basis of the Monte Carlo method.

(8) The illumination control device according to (7), in which

the light beam calculation unit calculates the number of light beams according to the brightness of the light source.

(9) The illumination control device according to (7) or (8), in which

the light beam calculation unit selects a lenslet that emits each light beam on the basis of an intersection of the light beam with a surface of the illumination device and defines a light beam group to be emitted by each lenslet, and

the pixel value determination unit selects a direction closest to each light beam in the group from among a finite number of directions in which the lenslet can emit light beams and determines a pixel value of a pixel that emits the light beam on the basis of a parameter allocated to the light beam.

(10) The illumination control device according to (9), in which

the pixel value determination unit determines a color and brightness of each pixel on the basis of a relationship between the brightness of the pixel and brightness of light emitted from the lenslet.

(11) An illumination control method for controlling an illumination device including a spatial light modulator and a lenticular sheet, the illumination control method including:

determining information regarding a position and a type of a light source;

performing light beam calculation for calculating a light beam to be emitted from each point on a surface of the illumination device in order to reproduce the determined light source; and

performing pixel value determination for determining a pixel value of each pixel of the spatial light modulator to realize the calculated light beam.

(12) An illumination device including:

a spatial light modulator;

a backlight; and

a lenticular sheet configured to control a direction of light emitted from each pixel of the spatial light modulator, in which

the lenticular sheet includes a plurality of lenslets and a frame that supports the plurality of lenslets on a two-dimensional plane.

(13) The illumination device according to (12), in which the plurality of lenslets is fixed to the frame with a heat resistance adhesive.

(14) An illumination system including:

an illumination device including a spatial light modulator and a lenticular sheet;

a user interface in which information regarding a position and a type of a light source is input; and

an illumination control unit configured to calculate a light beam to be emitted from each point on a surface of the illumination device in order to reproduce the light source determined on the basis of the input, determine a pixel value of each pixel of the spatial light modulator to realize the light beam, and control the spatial light modulator.

### REFERENCE SIGNS LIST

100 Illumination system
110 Illumination device
111 Spatial light modulator (SLM)
112 Backlight
113 Lenticular sheet
120 Illumination control unit
121 Light source position and type determination unit
122 Light beam calculation unit
123 Pixel value determination unit
124 SLM control unit
130 User interface

1. An illumination control device that controls an illumination device including a spatial light modulator and a lenticular sheet, the illumination control device comprising:
a determination unit configured to determine information regarding a position and a type of a light source;
a light beam calculation unit configured to calculate a light beam to be emitted from each point on a surface of the illumination device in order to reproduce the determined light source;
a pixel value determination unit configured to determine a pixel value of each pixel of the spatial light modulator to realize the calculated light beam; and
a control unit configured to control the spatial light modulator on a basis of the determined pixel value.

2. The illumination control device according to claim 1, wherein
the determination unit determines the information regarding the position and the type of the light source on a basis of an input to a user interface.

3. The illumination control device according to claim 2, further comprising:
the user interface.

4. The illumination control device according to claim 2, wherein
the user interface presents a selectable light source preset.

5. The illumination control device according to claim 2, wherein
the user interface receives an input of a parameter including at least one of brightness of a light source, a color of light, a change with time, and installation of a mask that shields a part of light emitted from the light source.

6. The illumination control device according to claim 2, wherein
the user interface receives a drag operation performed to instruct a position or a direction of a light source.

7. The illumination control device according to claim 1, wherein
the light beam calculation unit calculates a predetermined number of light beams emitted from the light source on a basis of the Monte Carlo method.

8. The illumination control device according to claim 7, wherein
the light beam calculation unit calculates the number of light beams according to brightness of the light source.

9. The illumination control device according to claim 7, wherein
the light beam calculation unit selects a lenslet that emits each light beam on a basis of an intersection of the light beam with a surface of the illumination device and defines a light beam group to be emitted by each lenslet, and
the pixel value determination unit selects a direction closest to each light beam in the group from among a finite number of directions in which the lenslet can emit light beams and determines a pixel value of a pixel that emits the light beam on a basis of a parameter allocated to the light beam.

10. The illumination control device according to claim 9, wherein
the pixel value determination unit determines a color and brightness of each pixel on a basis of a relationship between brightness of the pixel and brightness of light emitted from the lenslet.

11. An illumination control method for controlling an illumination device including a spatial light modulator and a lenticular sheet, the illumination control method comprising:
determining information regarding a position and a type of a light source;
performing light beam calculation for calculating a light beam to be emitted from each point on a surface of the illumination device in order to reproduce the determined light source; and
performing pixel value determination for determining a pixel value of each pixel of the spatial light modulator to realize the calculated light beam.

12. An illumination device comprising:
a spatial light modulator;
a backlight; and
a lenticular sheet configured to control a direction of light emitted from each pixel of the spatial light modulator, wherein
the lenticular sheet includes a plurality of lenslets and a frame that supports the plurality of lenslets on a two-dimensional plane.

13. The illumination device according to claim 12, wherein
the plurality of lenslets is fixed to the frame with a heat resistance adhesive.

14. An illumination system comprising:
an illumination device including a spatial light modulator and a lenticular sheet;
a user interface to which information regarding a position and a type of a light source is input; and
an illumination control unit configured to calculate a light beam to be emitted from each point on a surface of the illumination device in order to reproduce the light source determined on a basis of the input, determine a pixel value of each pixel of the spatial light modulator to realize the light beam, and control the spatial light modulator.
